(19) United States
(12) Patent Application Publication
(10) Pub. No.: US 2024/0202582 A1
(43) Pub. Date: Jun. 20, 2024

(54) MULTI-STAGE MACHINE LEARNING MODEL CHAINING

(71) Applicant: Microsoft Technology Licensing, LLC, Redmond, WA (US)

(72) Inventors: Samuel Edward SCHILLACE, Portola Valley, CA (US); Umesh MADAN, Bellevue, WA (US); Devis LUCATO, Kirkland, WA (US)

(73) Assignee: Microsoft Technology Licensing, LLC, Redmond, WA (US)

(21) Appl. No.: 18/122,575

(22) Filed: Mar. 16, 2023

Related U.S. Application Data
(60) Provisional application No. 63/433,627, filed on Dec. 19, 2022.

(51) Int. Cl. G06N 20/00

(52) U.S. Cl. CPC G06N 20/00

(57) ABSTRACT

A skill chain comprised of a set of ML model evaluations with which to process an input is generated and used to ultimately produce a model output accordingly. Each ML model evaluation corresponds to a “model skill” of the skill chain. Intermediate output that is generated by a first ML evaluation for a first model skill of the skill chain may subsequently be processed as input to a second ML evaluation for a second model skill of the skill chain, thereby ultimately generating model output for the given input. Such a skill chain can include any number skills according to any of a variety of structures and need not be evaluations using the same ML model.

### CROSS-REFERENCE TO RELATED APPLICATION

This application claims priority to U.S. Provisional Application No. 63/433,627, titled “Multi-Stage Machine Learning Model Chaining,” filed on Dec. 19, 2022, the entire disclosure of which is hereby incorporated by reference in its entirety.

### BACKGROUND

Singular evaluations with a machine learning model may have limited utility, especially for more complex tasks and in instances where the user is unfamiliar with the machine learning model and/or the task at hand. Accordingly, such evaluations may result in a diminished user experience, increased user frustration, and/or wasted computational resources, among other detriments.

It is with respect to these and other general considerations that embodiments have been described. Also, although relatively specific problems have been discussed, it should be understood that the embodiments should not be limited to solving the specific problems identified in the background.

### SUMMARY

Aspects of the present application relate to multi-stage machine learning model chaining, where a skill chain comprised of a set of ML model evaluations with which to process an input is generated and used to ultimately produce a model output accordingly. Each ML model evaluation corresponds to a “model skill” of the skill chain. For example, a model skill has an associated prompt template, which is used to generate a prompt (e.g., including input and/or context) that is processed using a corresponding ML model to generate model output accordingly. In other examples, an ML model associated with a model skill need not have an associated prompt template, as may be the case when prompting is not used by the ML model when processing input to generate model output.

Intermediate output that is generated by a first ML evaluation for a first model skill of the skill chain may subsequently be processed as input to a second ML evaluation for a second model skill of the skill chain, thereby ultimately generating model output for the given input. Such a skill chain can include any number skills according to any of a variety of structures and need not be evaluations using the same ML model.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which multi-stage machine learning model chaining may be used according to aspects of the present disclosure.

FIG. 2 illustrates an overview of an example conceptual diagram for processing a user input to generate model output using chained machine learning models according to according to aspects described herein.

FIG. 3 illustrates an overview of an example method for processing a user input to generate model output according to aspects described herein.

FIG. 4 illustrates an overview of an example method for processing user input according to a prompt using a generative ML model according to aspects described herein.

FIGS. 5A and 5B illustrate overviews of an example generative machine learning model that may be used according to aspects described herein.

FIG. 6 is a block diagram illustrating example physical components of a computing device with which aspects of the disclosure may be practiced.

FIG. 7 is a simplified block diagram of a computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a machine learning (ML) model produces model output based on an input (e.g., as may be received from a user). For example, natural language input from a user is processed using a generative ML model to produce model output for the natural language input accordingly. However, the limited nature of such a singular evaluation may result in reduced utility, especially in instances where a user is inexperienced/unfamiliar with the ML model (e.g., such that the user may provide input that results in limited utilization of the ML model and/or causes the ML model to behave unexpectedly). Similarly, use of an ML model through a singular evaluation may limit the tasks for which the model may be used, among other detriments.

Accordingly, aspects of the present application relate to multi-stage machine learning model chaining, where an input is processed using a set of ML model evaluations (e.g., that are chained together in a “skill chain”) to ultimately produce a model output for a given input. Each ML model evaluation corresponds to a “model skill” of the skill chain. For example, a model skill has an associated prompt template, which is used to generate a prompt (e.g., including input and/or context) that is processed using a corresponding ML model to generate model output accordingly. In other examples, an ML model associated with a model skill need not have an associated prompt template, as may be the case when prompting is not used by the ML model when processing input to generate model output.

Intermediate output generated by a first skill of a skill chain may subsequently be processed by a second skill to generate subsequent output accordingly. Such a skill chain can include any number of skills and it will be appreciated that model skills need not be associated with the same ML model. For instance, a generative model may generate natural language output, while a recognition model (or any of a variety of other types of ML models) may process intermediate output from the generative model to produce model output accordingly. Output of the recognition model may be provided as ultimate model output or may be intermediate output that is processed using another skill of the skill chain.

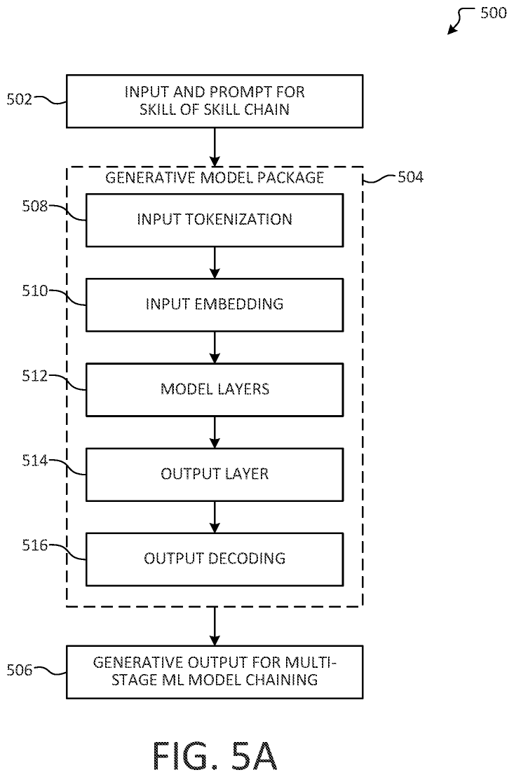

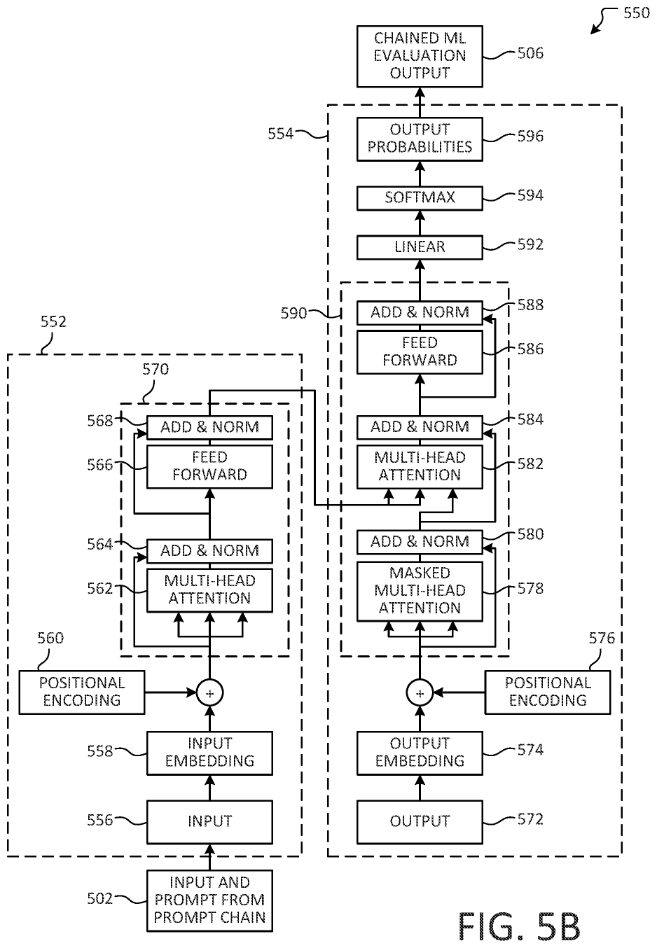

A generative model (also generally referred to herein as a type of ML model) used according to aspects described herein may generate any of a variety of output types (and may thus be a multimodal generative model, in some examples) and may be a generative transformer model and/or a large language model (LLM), a generative image model, in some examples. Example ML models include, but are not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox. Additional examples of such aspects are discussed below with respect to the generative ML model illustrated in FIGS. 5A-5B.

Output of a skill that is processed by a subsequent skill may be referred to herein as “intermediate output.” Example intermediate output includes, but is not limited to, natural language output, image data output, video data output, programmatic output, and/or binary output. It will therefore be appreciated that intermediate output may have any number of output “streams” (e.g., each having an associated content type).

In examples, the intermediate output comprises structured output, which may include one or more tags, key/value pairs, and/or metadata, among other examples. For example, a stream may be denoted according to an associated tag within such structured output. In examples, a prompt template of a skill defines or otherwise includes an indication relating to such structured output, thereby causing the generative ML model associated with the skill to produce structured output accordingly. As such, use of structured output may increase the degree to which model output is deterministic and may therefore improve reliability when chaining multiple ML model evaluations together according to aspects described herein. In other examples, intermediate output may be similar to ultimate model output that may otherwise be provided to a user or for further processing by an application, among other examples.

According to aspects described herein, skills may be chained together according to any of a variety of techniques. For example, a skill chain may include one or more sequential skills, a hierarchical set of skills, a set of parallel skills, and/or a skill that is dependent on or otherwise processes output from two or more skills, among other examples. It will therefore be appreciated that a skill chain is a graph or may be arranged according to any of a variety of other data structures. Additionally, a skill chain may include any of a variety of other types of skills. For example, one or more model skills may be chained together with a programmatic skill. For example, a programmatic skill may read the content of a file, obtain data from a data source and/or from a user, send an electronic message containing model output, create a file containing model output, and/or execute programmatic output that is generated by a model skill.

In examples, a skill library stores model and/or programmatic skills, from which a set of skills may be identified and used to generate a skill chain accordingly (e.g., thereby performing a set of associated ML model evaluations). As an example, a chain orchestrator may extract an intent from a given input (e.g., from a user and/or an application), which may be mapped to one or more skills of the skill library, thereby generating a chain model and/or programmatic skills with which to process the input. In examples, new skills are added to the skill library (e.g., by an application or by a user or developer), such that they may be dynamically identified and used as part of a skill chain with which to process a given input according to aspects described herein.

As noted above, a skill may include or otherwise be associated with a prompt template. One or more fields, regions, and/or other parts of the prompt template may be populated (e.g., with input and/or context), thereby generating a prompt to be processed by an ML model according to aspects described herein. For instance, the prompt is used to prime the ML model, thereby inducing the model to generate output corresponding to the prompt template. It will be appreciated that a prompt template may include any of a variety of data, including, but not limited to, natural language, image data, audio data, video data, and/or binary data, among other examples.

Thus, in examples, a skill as used herein invokes processing by an ML model (e.g., according to an associated prompt template) to process a given input (e.g., as may be received from a user or as may be intermediate output from another skill). In examples, context is processed as part of the ML model evaluation. For example, an input may include an indication as to context, the skill may define a context that is provided to the ML model, and/or a chain orchestrator (e.g., that defines and/or manages processing of a skill chain) may determine context that is used for ML model evaluation accordingly, among other examples.

In addition to chaining prompts for ML model evaluations, an associated context may be shared among or otherwise used by a plurality of model skills. For example, at least a part of the context that is used for processing associated with a first model skill (or, in other examples, a plurality of model skills) may be used by a second model skill. In examples, the context is changed by a first model evaluation (e.g., of the first model skill) that occurs prior to or contemporaneously with processing by a second ML model evaluation (e.g., for the second model skill), such that the second ML model evaluation uses the updated context accordingly.

As a result of the disclosed chaining techniques, it may be possible to accomplish tasks and/or generate model output that would otherwise not have been possible via a singular ML model evaluation. For instance, information can be obtained from one or more data sources and/or input can be requested from the user while processing a skill chain, which is then used in subsequent processing (e.g., by one or more subsequent skills of the skill chain). As another example, evaluation of the skill chain may be dynamically adapted as a result of a constituent evaluation, thereby affecting one or more future evaluations of the skill chain (e.g., by adding an evaluation, removing an evaluation, or changing an evaluation). Further, the skill chain itself may be managed, orchestrated, and/or derived by an ML model (e.g., by a generative ML model based on natural language input that is received from a user and/or input that is generated by or otherwise received from an application). Additionally, given different ML models may be chained together (e.g., which may each generate a different type of model output), the resulting model output may be output that would not otherwise be produced as a result of processing by a single ML model.

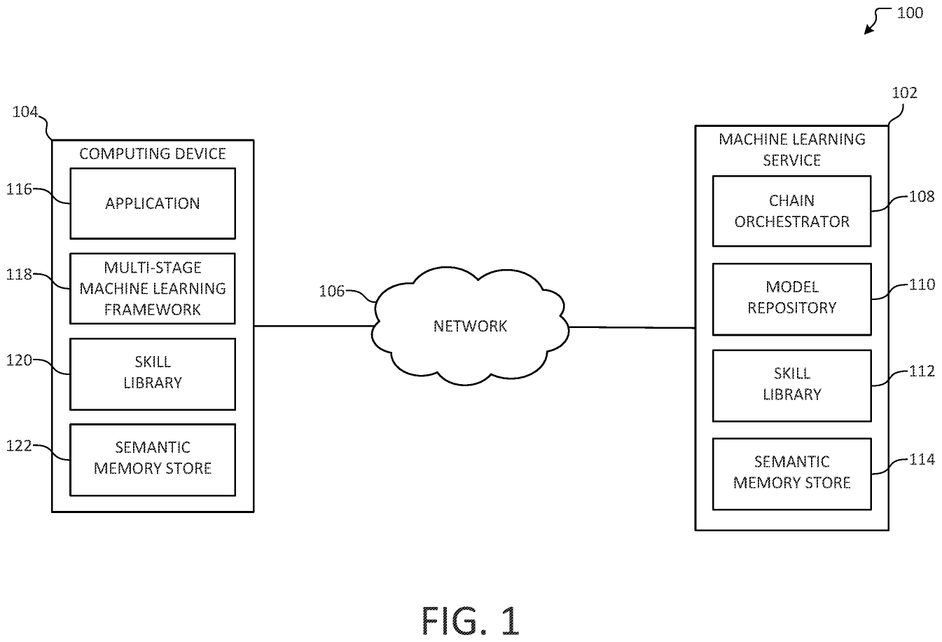

FIG. 1 illustrates an overview of an example system 100 in which multi-stage machine learning model chaining may be used according to aspects of the present disclosure. As illustrated, system 100 includes machine learning service 102, computing device 104, and network 106. In examples, machine learning service 102 and computing device 104 communicate via network 106, which may comprise a local area network, a wireless network, or the Internet, or any combination thereof, among other examples.

As illustrated, machine learning service 102 includes chain orchestrator 108, model repository 110, skill library 112, and semantic memory store 114. In examples, machine learning service 102 receives a request from computing device 104 (e.g., from multi-stage machine learning framework 118) to generate model output, which may be generated using a skill chain as described herein. As noted above, the request may include an input (e.g., as may be a user input that was received from a user at computing device 104 and/or that was generated by application 116).

The received request is processed by chain orchestrator 108, which may identify one or more ML models from model repository 110 and process the input accordingly. In example, chain orchestrator 108 processes the request to generate a skill chain with which to generate the model output (e.g., using one or more models of model repository 110). For example, chain orchestrator 108 uses a generative ML model to process at least a part of the input (e.g., in conjunction with a prompt that was generated from a prompt template using the input), thereby generating a skill chain that includes one or more model skills (and, in some examples, one or more programmatic skills) accordingly. Chain orchestrator 108 then processes the resulting skill chain according to aspects described herein, for example using one or more models of model repository 110, skills of skill library 112 and/or 120, and/or context from semantic memory store 114 and/or 122.

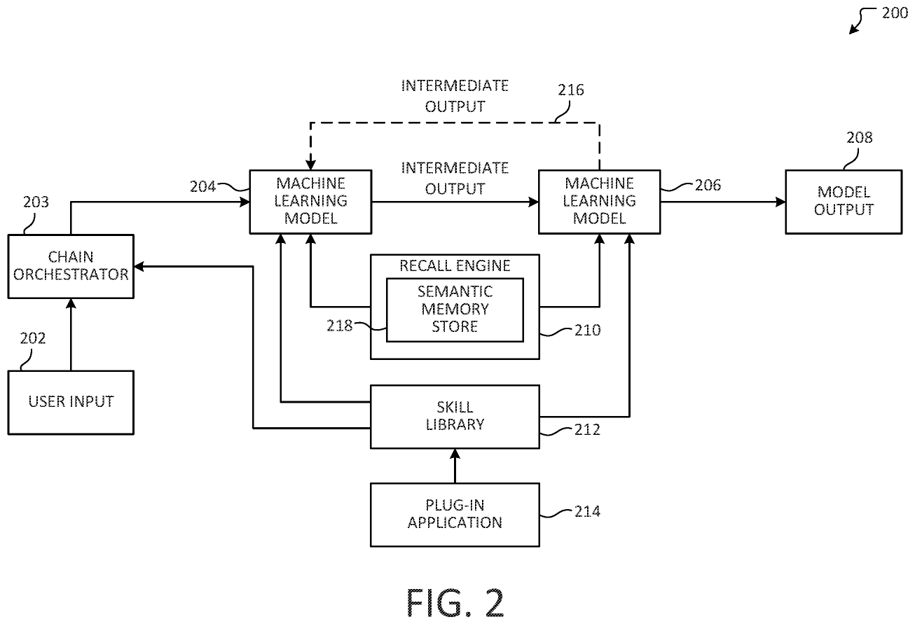

In other examples, the request includes a prompt that is used to prime the ML model (e.g., that was generated using a prompt template for a skill from skill library 120 of computing device 104). As another example, the request includes an indication of a skill in skill library 112, such that chain orchestrator 108 generates a corresponding prompt based on the skill from skill library 112 accordingly. Additionally, or alternatively, the request includes a context with which the request is to be processed (e.g., from semantic memory store 122 of computing device 104). As a further example, the request includes an indication of context in semantic memory store 114, such that chain orchestrator 108 obtains the context from semantic memory store 114 accordingly. Additional examples of these and other aspects are discussed below with respect to semantic memory store 218 and corresponding recall engine 210 in FIG. 2. Such aspects may be used in instances where multi-stage machine learning framework 118 performs aspects similar to chain orchestrator 108, such that multi-stage machine learning framework 118 generates a skill chain and/or manages processing of a skill chain accordingly.

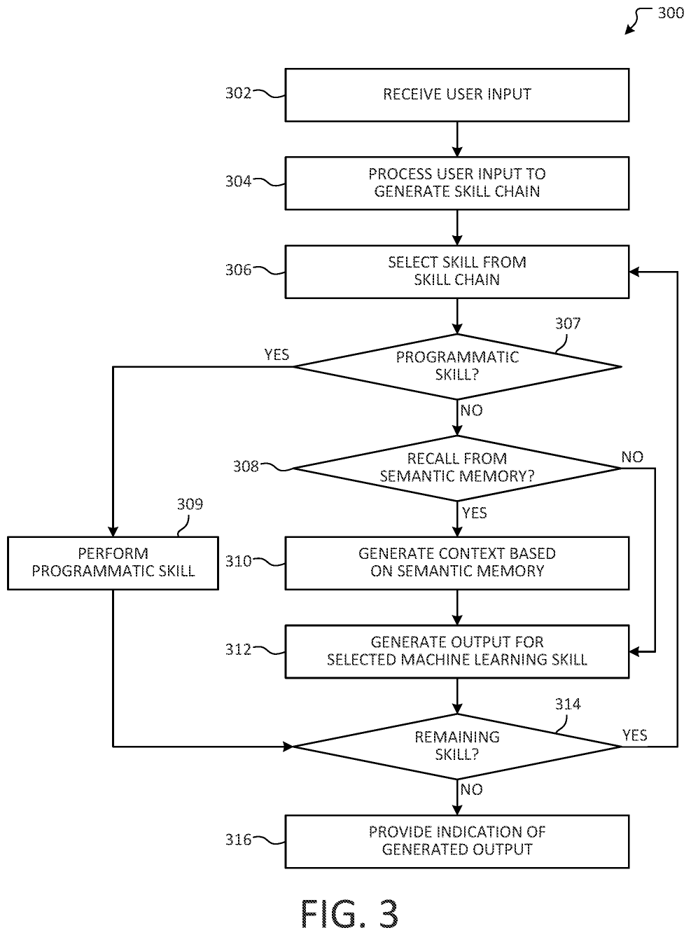

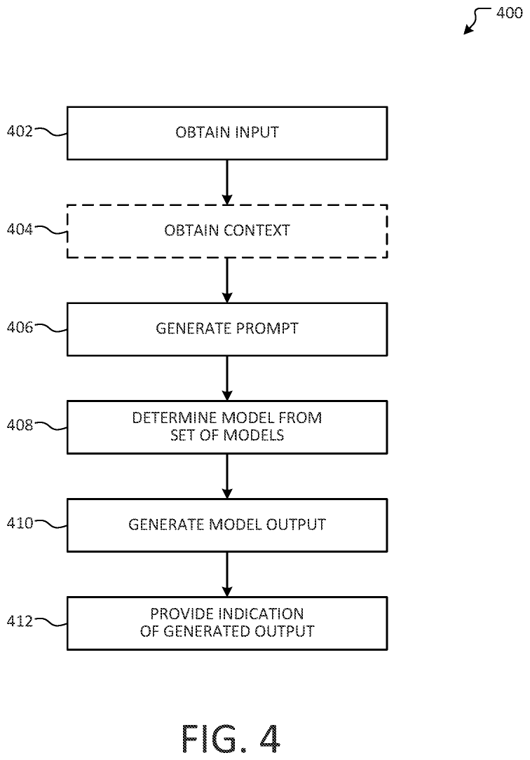

In some instances, chain orchestrator 108 obtains additional information that is used when processing a request (e.g., as may be obtained from a remote data source or as may be requested from a user of computing device 104). For instance, chain orchestrator 108 may determine to obtain additional information for a given evaluation of a skill chain, among other examples. As an example, additional information may be obtained via a programmatic skill (e.g., as may have been included in a skill chain by chain orchestrator 108). Examples of such aspects are discussed in greater detail below with respect to methods 300 and 400 of FIGS. 3 and 4, respectively.

Model repository 110 may include any number of different ML models. For example, model repository 110 may include foundation models, language models, speech models, video models, and/or audio models. As used herein, a foundation model is a model that is pre-trained on broad data that can be adapted to a wide range of tasks (e.g., models capable of processing various different tasks or modalities). In examples, a multimodal machine learning model of model repository 110 may have been trained using training data having a plurality of content types. Thus, given content of a first type, an ML model of model repository 110 may generate content having any of a variety of associated types. It will be appreciated that model repository 110 may include a foundation model as well as a model that has been finetuned (e.g., for a specific context and/or a specific user or set of users), among other examples.

Turning now to computing device 104, computing device 104 includes application 116, multi-stage machine learning framework 118, skill library 120, and semantic memory store 122. In examples, application 116 uses multi-stage machine learning framework 118 to process user input and generate model output accordingly, which may be presented to a user of computing device 104 and/or used for subsequent processing by application 116, among other examples.

In examples, aspects of multi-stage machine learning framework 118 are similar to chain orchestrator 108 and are therefore not necessarily redescribed in detail. For example, in addition to or as an alternative to skill chain generation by chain orchestrator 108, multi-stage machine learning framework 118 may generate and/or manage evaluation of a skill chain according to aspects described herein. For example, multi-stage machine learning framework 118 provides an indication of user input to machine learning service 102, such that a skill chain is generated by machine learning service 102 and is received by computing device 104 in response. Accordingly, multi-stage machine learning framework 118 manages the evaluation of the skill chain (e.g., generating subsequent requests to machine learning service 102 for constituent model skills) according to one or more associated prompt templates (e.g., as may be stored by skill library 112/120) and/or based on associated context (e.g., from semantic memory store 114/122). In examples, multi-stage machine learning framework 118 requests model output from machine learning service 102 for model skills of the skill chain, while a programmatic skill of the skill chain may be processed local to (or, in other examples, remote from) computing device 104.

It will therefore be appreciated that the disclosed aspects may be implemented according to any of a variety of paradigms. For example, skill chain generation/orchestration and/or prompt generation (e.g., based on a prompt template of a model skill) may be performed client side (e.g., by multi-stage machine learning framework 118), server side (e.g., by chain orchestrator 108), or any combination thereof, among other examples. For instance, multi-stage machine learning framework 118 may perform a first ML evaluation associated with a first model skill stored by skill library 120 of computing device 104, while a second ML evaluation is performed by machine learning service 102 based on a second model skill that is stored by skill library 112. Multi-stage machine learning framework 118 may be provided as part of an operating system of computing device 104 (e.g., as a service, an application programming interface (API), and/or a framework), may be made available as a library that is included by application 116 (or may be more directly incorporated by an application), or may be provided as a standalone application, among other examples.

As another example, a user interface is provided via which a user may interact with a multi-stage machine learning framework and/or chain orchestrator. For example, machine learning service 102 may additionally, or alternatively, implement aspects similar to multi-stage machine learning framework 118, such that machine learning service 102 provides a website via which a user may interact with a console or terminal interface of the multi-stage machine learning framework accordingly. The console may include a text-based user interface via which a user inputs skills (e.g., model skills and/or programmatic skills) that may be chained together. For example, skills may be chained together using a pipe (“|”) operator, thereby piping output of one skill (e.g., a first model skill) as input to another skill (e.g., a second model skill). It will be appreciated that inputs and/or outputs of one or more skills may additionally, or alternatively, be redirected according to any of a variety of other techniques (e.g., using “<<”, “>”, and/or “>>” operators).

As a further example, computing device 104 may include a user interface that is part of an application (e.g., application 116) or a plurality of applications (e.g., as a shared framework or as functionality that is provided by an operating system of computing device 104). In such an example, natural language input may be provided via the user interface (e.g., as text input and/or as voice input), which may be processed according to aspects described herein and used to generate a skill chain accordingly. In examples, a skill of the skill chain may interact with one or more command interfaces, each of which may be associated with an application (e.g., application 116) and/or an operating system of computing device 104, among other examples. For example, the operating system may provide a command interface via which interactions may be performed, for example through an accessibility API and/or an extensibility API.

In examples, a model skill may generate programmatic output that is executed, parsed, or otherwise processed (e.g., as a programmatic skill) to interact with various functionality and/or other aspects of computing device 104 (e.g., application 116, system preferences, etc.) based on the received natural language input. As such, a user of computing device 104 may use such an interface to interact with application/device functionality via multi-stage machine learning model chaining according to aspects described herein. While examples are described in which user input is received as natural language input and that subsequently causes a chain of ML evaluations, it will be appreciated that similar techniques may be used in instances where such multi-stage machine learning model chaining is bound to a user interface element (e.g., in response to user actuation of a button, a scroll bar, a window, or a menu) or other software processing, among other examples.

FIG. 2 illustrates an overview of an example conceptual diagram 200 for processing a user input to generate model output using chained machine learning models according to according to aspects described herein. As illustrated, diagram 200 processes user input 202 according to a set of models (e.g., ML models 204 and 206, as orchestrated by chain orchestrator 203) to generate model output 208. For example, user input 202 may be received from a computing device, such as computing device 104 in FIG. 1. Aspects of chain orchestrator 203 may be similar to those discussed above with respect to chain orchestrator 108 and are therefore not necessarily redescribed below in detail.

User input 202 may include any of a variety of input, including, but not limited to, natural language input, command-line input, input that is received via a framework or an application, and/or input that is received via a central service (e.g., of an operating system) or a uniform resource identifier (URI) handler, among other examples. While examples are described herein with reference to natural language input, it will be appreciated that any of a variety of additional or input types may be received, including, but not limited to, image input and/or video input. Further, natural input may include any of a variety of input, such as text input or speech input.

As illustrated, user input 202 is processed by chain orchestrator 203. In examples, chain orchestrator 203 processes user input 202 to generate a skill chain that includes a plurality of model skills (e.g., including an evaluation by ML model 204 and ML model 206) to ultimately generate model output 208 according to aspects described herein. Such aspects may be similar to those discussed above with respect to chain orchestrator 108, such that user input 202 is processed to extract an intent that is mapped to one or more skills (e.g., of skill library 212).

To generate a skill chain, an orchestration prompt may be generated by chain orchestrator 203, which includes an indication of one or more skills from skill library 212 (which is also referred to herein as a “skill listing”) and at least a part of user input 202, such that the generative ML model generates a skill chain with which user input 202 is processed. Thus, chain orchestrator 203 maps one or more intents of user input 202 to one or more model and/or programmatic skills of skill library 212 accordingly. Additional examples of these and other aspects of chain orchestrator 203 are discussed below with respect to operation 304 of method 300 in FIG. 3.

In examples, the skill listing is dynamically generated. As an example, skill library 212 may include one or more files that each define one or more skills with which input (e.g., user input and/or intermediate output) may be processed. As another example, skill library 212 includes a database that stores a listing of skills. In some instances, a new skill may be registered (e.g., in the database or in an index), thereby indicating that the skill is available for use as part of a skill chain. For example, plug-in application 214 (e.g., aspects of which may be similar to application 116) may include one or more skills that are registered within skill library 212, such that processing using a skill of plug-in application 214 may be performed according to aspects described herein. It will therefore be appreciated that a set of skills in skill library 212 may be stored using any of a variety of techniques.

In an example, chain orchestrator 203 lists the content of skill library 212 when generating the skill listing. A skill may include or otherwise have an associated description of its functionality (e.g., a manual page or usage information, such as syntax and/or an indication of one or more inputs/outputs), at least a part of which may be included in the skill listing that is generated by chain orchestrator 203 and used to generate the skill chain accordingly.

Chain orchestrator 203 thus manages processing of user input 202 according to the generated skill chain. As noted above, such a skill chain may include one or more sequential skills, a hierarchical set of skills, a set of parallel skills, and/or a skill that is dependent on or otherwise processes output from two or more prior skills, among other examples. In examples, the evaluation order of the skill chain is determined based on the available skills of skill library 212. Additionally, or alternatively, the skill chain includes one or more programmatic skills, though the instant example is an example in which two model skills are used, corresponding to ML models 204 and 206.

As illustrated, once a skill chain is generated by chain orchestrator 203, user input 202 is processed by ML model 204 to generate intermediate output. For example, a prompt template corresponding with a first model skill may be populated or otherwise processed to generate a prompt (e.g., including at least a part of user input 202 and/or context from semantic memory store 218) that is processed by ML model 204 accordingly. Accordingly, intermediate output from ML model 204 is then processed by ML model 206. ML models 204 and 206 may each be the same or a similar model (e.g., generating the same content type(s) and/or trained using similar training data) or, as another example, ML models 204 and 206 may each be different models (e.g., generating different sets of content types). When processing input (e.g., user input 202 or intermediate output from a preceding evaluation), ML models 204 and 206 may each use a skill from skill library 212 (e.g., as may have been determined or otherwise identified by chain orchestrator 203 according to aspects described herein).

In examples, ML model 204 and ML model 206 each use context obtained from recall engine 210, as may be stored by semantic memory store 218. For example, it may be determined (e.g., by chain orchestrator 203 and/or by ML model 204 or 206) that processing associated with a skill should be performed according to context from recall engine 210. In other examples, a skill from skill library 212 may indicate (e.g., as part of an associated prompt template) that context should be obtained from semantic memory store 218, such that recall engine 210 is used to obtain such context accordingly. Thus, it will be appreciated that context may be obtained for a skill as a result of any of a variety of determinations and/or indications, among other examples.

As an example, semantic memory store 218 stores semantic embeddings (also referred to herein as “semantic addresses”) associated with ML model 204 and/or ML model 206, each of which may correspond to one or more content objects. In examples, an entry in semantic memory store 218 includes one or more semantic embeddings corresponding to a context object and/or the context object itself or a reference to the context object, among other examples.

In examples, semantic memory store 218 stores embeddings that are associated with one or more models (e.g., ML model 204 and/or 206) and their specific versions, which may thus represent the same or similar content but in varying semantic embedding spaces (e.g., as is associated with each model/version). Further, when a new model is added or an existing model is updated, one or more entries within semantic memory store 218 may be reencoded (e.g., by generating a new semantic embedding according to the new embedding space). In this manner, a single content object entry within semantic memory store 218 may have a locatable semantic address across models/versions, thereby enabling retrieval of content objects based on a similarity determination (e.g., as a result of an algorithmic comparison) between a corresponding semantic address and a semantic context indication.

As a result, an input embedding may be generated (e.g., as may be associated with user input 202 and/or processing by ML model 204 or 206). For example, the input embedding may be generated by a machine learning model that encodes an intent corresponding to user input 202 accordingly. Additionally, or alternatively, the input embedding may be generated based on any of a variety of other input (e.g., audio and/or visual input) that is received by a computer. Additional and/or alternative methods for generating an input embedding may be recognized by those of skill in the art.

Recall engine 210 may thus identify one or more content objects that are provided as context for processing associated with a skill based on the input embedding. For example, a set of semantic embeddings that match the input embedding (e.g., using cosine distance, another geometric n-dimensional distance function, or other algorithmic similarity metric) may be identified and used to identify one or more corresponding content objects accordingly. As noted above, processing by ML model 204 and/or ML model 206 may add, remove, or otherwise modify one or more entries of semantic memory store 218, such that context from recall engine 210 that is used by a subsequent skill may be affected by one or more previous skills.

As a result of the multi-stage ML model chaining performed by ML models 204 and 206, model output 208 is generated. Thus, one or more model skills of a skill chain may each generate intermediate output (e.g., structured output), while a final skill of the skill chain (e.g., an ML model evaluation by ML model 206, as illustrated) may generate model output 208 based on such intermediate output. As an example, final model output produced by ML model 206 includes, but is not limited to, natural language output, speech and/or audio output, image output, video output, and/or programmatic output.

Diagram 200 is illustrated in an example where the skill chain includes two model skills (e.g., corresponding to ML model 204 and ML model 206). Arrow 216 is provided to illustrate that, in other examples, additional model skills may be included (e.g., associated with ML model 204, ML model 206, and/or any of a variety of other ML models, not pictured). Further, while diagram 200 depicts an example in model skills are sequential, it will be appreciated that parallel skills, hierarchical ML skills, and/or skills that depend on output from multiple prior skills may be used in other instances, among other examples. Additionally, as noted above, a skill chain may further include one or more programmatic skills in other examples.

FIG. 3 illustrates an overview of an example method 300 for processing a user input to generate model output according to aspects described herein. In examples, aspects of method 300 are performed by a chain orchestrator (e.g., chain orchestrator 108 in FIG. 1 or chain orchestrator 203 in FIG. 2) and/or by a multi-stage machine learning framework (e.g., multi-stage machine learning framework 118), among other examples.

As illustrated, method 300 begins at operation 302, where user input is received. In examples, the user input may be received from a computing device (e.g., computing device 104 in FIG. 1), as may be the case when aspects of method 300 are performed by a machine learning service (e.g., machine learning service 102 in FIG. 1). As another example, the user input is received from an application (e.g., application 116), from a service, or from other software of a computing device (e.g., computing device 104), as may be the case when aspects of method 300 are performed by a multi-stage machine learning framework (e.g., multi-stage machine learning framework 118). In examples, the received input may be similar to user input 202 discussed above with respect to FIG. 2. The received user input may include natural language input (e.g., text and/or speech input), image input, and/or video input, among any of a variety of other inputs.

Method 300 progresses to operation 304, where the received input is processed to generate a skill chain (e.g., corresponding to a set of ML evaluations and, in some examples, further corresponding to a set of programmatic evaluations, according to aspects described herein). For example, a prompt is generated that is processed by a generative ML model to generate the skill chain accordingly. The prompt may be generated based on a prompt template that is populated to include at least a part of the input that was received at operation 302. In examples, the prompt template is further populated with a skill listing (e.g., from a skill library, such as skill library 112, 120, and/or 212 in FIGS. 1 and 2).

In examples, a chain orchestrator (e.g., chain orchestrator 108) of a machine learning service generates the skill chain. As another example, a request is provided to the machine learning service to process the input, such that an indication of the skill chain is received in response, as may be the case when aspects of method 300 are performed by a multi-stage machine learning framework of a client computing device (e.g., computing device 104 in FIG. 1). As a further example, at least a part of such skill chain generation is performed local to the computing device, as may be the case when a generative ML model for performing such aspects is locally available. As noted above, the generated skill chain may include one or more sequential skills, a hierarchical set of skills, a set of parallel skills, and/or a skill that is dependent on or otherwise processes output from two or more prior skills, among other examples.

While examples are described in which a generative ML model is used to generate a skill chain (e.g., with respect to chain orchestrator 108, chain orchestrator 203, and operation 304 in FIGS. 1, 2, and 3, respectively), it will be appreciated that any of a variety of additional or alternative techniques may be used. As an example, a semantic store similar to semantic memory store 218 may additionally, or alternatively, be used to store one or more embeddings associated with a skill of a skill library (e.g., as may be generated based on an associated skill description, manual page, and/or at least a part of an associated prompt template). For instance, an input embedding may be generated for the input that was received at operation 302 (e.g., thereby indicating one or more associated intents) and used to identify one or more skills having associated embeddings that match the input embedding (similar to aspects discussed above with respect to recall engine 210). The identified skills may thus form a skill chain accordingly.

As another example, a context may be provided to the generative ML model when generating the skill chain (e.g., which may be included as part of the generated prompt), as may be determined by a recall engine from a semantic memory engine, similar to recall engine 210 and semantic memory store 218 discussed above with respect to FIG. 2.

Flow progresses to operation 306, where a skill is selected from the skill chain that was generated at operation 304. In examples, the skill chain that was generated at operation 304 indicates an order, a hierarchy, and/or one or more interdependencies for constituent skills, such that a skill is selected at operation 306 accordingly.

At determination 307, it is determined whether the selected skill is a programmatic skill. As noted above, a skill chain may, in some examples, include a programmatic skill where any of a variety of processing is performed by a computing device. Accordingly, if it is determined that the selected skill is a programmatic skill, flow branches “YES” to operation 309, where the programmatic skill is processed. In examples, operation 309 comprises executing a command, obtaining additional information (e.g., from a user or from a data source), and/or affecting operation of an operating system or an application (e.g., via an API or a command interface), among other examples. In subsequent iterations of method 300, performing the programmatic skill at operation 309 may comprise executing programmatic output that was generated by a machine learning model according to aspects described herein. It will therefore be appreciated that any of a variety of programmatic operations may be performed when evaluating a skill chain. Flow then progresses to determination 314, which is discussed below.

However, if it is instead determined that the selected skill is not a programmatic skill (e.g., such that it is instead a model skill), flow branches “NO” to determination 308, where it is determined whether to recall context from a semantic memory store (e.g., semantic memory store 114, 122, and/or 210 in FIGS. 1 and 2). As discussed above, the determination may be based on a prompt template corresponding to the selected model skill. For example, the prompt template may indicate that context should be obtained from the semantic memory store and/or may include an indication as to what context should be obtained, if available. As another example, it may be automatically determined to recall context from the semantic memory store, as may be determined based on previous model skills that used the same or a similar prompt. Thus, it will be appreciated that context may be obtained from a semantic memory store for a model skill as a result of any of a variety of determinations and/or indications, among other examples.

If it is determined to recall context from the semantic memory, flow branches “YES” to operation 310, where context is generated based the semantic memory store. Such aspects may be similar to those discussed above with respect to recall engine 210 in FIG. 2, and are therefore not necessarily redescribed in detail below. For example, an input semantic embedding is generated based on the user input and/or the prompt template for which the ML evaluation is to be performed, such that one or more matching semantic embeddings may be identified from the semantic memory store. Content corresponding to the identified semantic embedding(s) is retrieved and used as context for the ML evaluation of the model skill accordingly. As noted above, the retrieved content may be included in a prompt that is generated according to the prompt template. It will be appreciated that context may be obtained from any of a variety of sources, including, but not limited to, a user's computing device (e.g., computing device 104 in FIG. 1) and/or a machine learning service (e.g., machine learning service 102), among other examples. By contrast, if it is instead determined not to recall context from the semantic memory store, flow instead branches “NO” from determination 308 to operation 312, which is discussed below.

Flow eventually progresses to operation 312, where output is generated for the selected machine learning skill. As discussed above, a prompt may be generated based on a prompt template, such that the prompt includes at least a part of the input and, in some examples, the generated context. It will be appreciated that, in other examples, an ML model associated with a model skill may not use prompting. Similar to operation 304, a request for ML processing may be provided to the machine learning service in instances where the skill chain generation aspects of method 300 are performed local to a client computing device, such that generated output is received from the machine learning service in response. In some examples, the generated output (e.g., as may be received as a response from the machine learning service) may be intermediate output, which, for example, includes structured output that is generated as a result of the prompt including an indication as to such structured output, as noted above. Additional example aspects of operation 312 are discussed below with respect to method 400 of FIG. 4.

At determination 314, it is determined whether there is a remaining skill in the skill chain that was generated at operation 304. In examples, the skill chain is updated as a result of operation 309 and/or 312 described above. Determination 314 may comprise evaluating the skill chain (e.g., as was generated at operation 304 and/or as may have been updated as a result of operation 309 and/or 312) to determine whether there is a skill that has not yet been processed. If it is determined that there is not a remaining skill, flow branches “NO” to operation 316, which is discussed below.

By contrast, if it is instead determined there is a remaining skill, flow branches “YES” and returns to operation 306, where a subsequent skill is selected. Thus, flow loops between operations 306-314 in instances where one or more skills remain. Subsequent iterations of operation 312 may use generated output of a previous iteration of operation 309 and/or 312 as input to a model skill when generating subsequent model output. Similarly, subsequent iterations of operation 309 may use generated output of a previous iteration of operation 309 and/or operation 312, in some examples. Additionally, or alternatively, at least a part of the received user input is used as input for a subsequent iteration of operation 309 and/or 312.

In addition to chaining ML evaluations together via subsequent iterations of operation 312, one or more contexts may be chained together as a result of subsequent iterations of operation 310 in some examples. For example, a context corresponding to a previous ML evaluation (e.g., as may have been generated by a previous iteration of operation 310 and/or updated by a previous iteration of operation 312) may be used as context for a subsequent ML evaluation by operation 312.

Eventually, method 300 arrives at operation 316, where an indication of the generated output is provided. For example, the indication may be provided to a client computing device, as may be the case in instances where aspects of method 300 are performed by a chain orchestrator of the machine learning platform. Additionally, or alternatively, the indication may be provided by a multi-stage machine learning framework of the client computing device. For example, the indication is provided to an application (e.g., application 116 in FIG. 1) for subsequent processing. In some instances, an indication of at least a part of the generated output is provided to a user of the computing device. As noted above, the resulting output may include any of a variety of content, including, but not limited to, natural language output, speech and/or audio output, image output, video output, and/or programmatic output. Method 300 terminates at operation 316.

FIG. 4 illustrates an overview of an example method 400 for processing user input according to a prompt using a generative ML model (also referred to herein as an ML model evaluation) according to aspects described herein. In examples, aspects of method 400 are performed as part of operation 312 discussed above with respect to method 300 of FIG. 3.

As illustrated, method 400 begins at operation 402, where input is obtained. Aspects of the obtained input may be similar to user input 202 discussed above with respect to FIG. 2 or that which is received at operation 302 of method 300 in FIG. 3 and are therefore not necessarily redescribed below in detail. For example, the input may be obtained from a user of a computing device (e.g., computing device 104 in FIG. 1). In some examples, the input is received as part of a request to generate model output according to aspects described herein (e.g., as a result of performing aspects of operation 312 discussed above with respect to method 300 of FIG. 3).

At operation 404, a context may be obtained. Operation 404 is illustrated using a dashed box to indicate that, in other examples, operation 404 may be omitted. Similar to operation 402, the context may be obtained as part of a request to generate model output in some examples. In other examples, the context may be obtained from a semantic memory store, as may be generated by a recall engine similar to recall engine 210 from semantic memory store 218, as was discussed above with respect to FIG. 2.

Flow progresses to operation 406, where a prompt is generated. In examples, an indication of a model skill (e.g., corresponding to a prompt template) is received as part of a received request (as noted above with respect to operation 402). In some instances, the prompt template may be obtained based on an association with the model skill in a skill library (e.g., skill library 112 and/or 120 in FIG. 1, and/or skill library 212 in FIG. 2). The prompt template is processed to incorporate at least a part of the obtained input and, in some examples, the obtained context. For example, one or more fields, regions, or other parts of the prompt template may be replaced or otherwise populated with such aspects, thereby generating a prompt with which model output may be generated for a given model skill.

Moving to operation 408, a model is determined from a set of models. In examples, a skill for which the prompt was generated at operation 406 may include an indication as to a model with which the generated prompt is to be processed. As another example, the received request may include such an indication. The model may be identified from a model repository, such as model repository 110 in FIG. 1. In other examples, such a determination need not be made, as may be the case when a machine learning service and/or an associated API via which the request was received performs processing with a single ML model.

Flow progresses to operation 410, where model output is generated. In examples, operation 410 comprises processing the prompt that was generated at operation 406 according to the ML model that was determined at operation 408. Aspects of an example ML model that may be used to perform such processing are described below with respect to FIGS. 5A-5B.

At operation 412, an indication of the generated output is provided. For example, a response to a request that was received as part of operation 402, 404, and/or 406 may be generated that includes at least a part of the model output. As noted above, the model output may include intermediate and/or structured output, as may be the case when the request corresponds to an intermediate ML evaluation of a skill chain. The indication of generated output may thus be received by the computing device, where subsequent processing may be performed accordingly (e.g., by a multi-stage machine learning framework and/or an application, such as multi-stage machine learning framework 118 and/or application 116, respectively). Method 400 terminates at operation 412.

FIGS. 5A and 5B illustrate overviews of an example generative machine learning model that may be used according to aspects described herein. With reference first to FIG. 5A, conceptual diagram 500 depicts an overview of pre-trained generative model package 504 that processes an input and a prompt 502 for a skill of a skill chain to generate model output for multi-stage ML model chaining 506 according to aspects described herein. Examples of pre-trained generative model package 504 includes, but is not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox.

In examples, generative model package 504 is pre-trained according to a variety of inputs (e.g., a variety of human languages, a variety of programming languages, and/or a variety of content types) and therefore need not be finetuned or trained for a specific scenario. Rather, generative model package 504 may be more generally pre-trained, such that input 502 includes a prompt that is generated, selected, or otherwise engineered to induce generative model package 504 to produce certain generative model output 506. For example, a prompt includes a context and/or one or more completion prefixes that thus preload generative model package 504 accordingly. As a result, generative model package 504 is induced to generate output based on the prompt that includes a predicted sequence of tokens (e.g., up to a token limit of generative model package 504) relating to the prompt. In examples, the predicted sequence of tokens is further processed (e.g., by output decoding 516) to yield output 506. For instance, each token is processed to identify a corresponding word, word fragment, or other content that forms at least a part of output 506. It will be appreciated that input 502 and generative model output 506 may each include any of a variety of content types, including, but not limited to, text output, image output, audio output, video output, programmatic output, and/or binary output, among other examples. In examples, input 502 and generative model output 506 may have different content types, as may be the case when generative model package 504 includes a generative multimodal machine learning model.

As such, generative model package 504 may be used in any of a variety of scenarios and, further, a different generative model package may be used in place of generative model package 504 without substantially modifying other associated aspects (e.g., similar to those described herein with respect to FIGS. 1, 2, 3, and 4). Accordingly, generative model package 504 operates as a tool with which machine learning processing is performed, in which certain inputs 502 to generative model package 504 are programmatically generated or otherwise determined, thereby causing generative model package 504 to produce model output 506 that may subsequently be used for further processing.

Generative model package 504 may be provided or otherwise used according to any of a variety of paradigms. For example, generative model package 504 may be used local to a computing device (e.g., computing device 104 in FIG. 1) or may be accessed remotely from a machine learning service (e.g., machine learning service 102). In other examples, aspects of generative model package 504 are distributed across multiple computing devices. In some instances, generative model package 504 is accessible via an application programming interface (API), as may be provided by an operating system of the computing device and/or by the machine learning service, among other examples.

With reference now to the illustrated aspects of generative model package 504, generative model package 504 includes input tokenization 508, input embedding 510, model layers 512, output layer 514, and output decoding 516. In examples, input tokenization 508 processes input 502 to generate input embedding 510, which includes a sequence of symbol representations that corresponds to input 502. Accordingly, input embedding 510 is processed by model layers 512, output layer 514, and output decoding 516 to produce model output 506. An example architecture corresponding to generative model package 504 is depicted in FIG. 5B, which is discussed below in further detail. Even so, it will be appreciated that the architectures that are illustrated and described herein are not to be taken in a limiting sense and, in other examples, any of a variety of other architectures may be used.

FIG. 5B is a conceptual diagram that depicts an example architecture 550 of a pre-trained generative machine learning model that may be used according to aspects described herein. As noted above, any of a variety of alternative architectures and corresponding ML models may be used in other examples without departing from the aspects described herein.

As illustrated, architecture 550 processes input 502 to produce generative model output 506, aspects of which were discussed above with respect to FIG. 5A. Architecture 550 is depicted as a transformer model that includes encoder 552 and decoder 554. Encoder 552 processes input embedding 558 (aspects of which may be similar to input embedding 510 in FIG. 5A), which includes a sequence of symbol representations that corresponds to input 556. In examples, input 556 includes input and prompt 502 corresponding to a skill of a skill chain, aspects of which may be similar to user input 202, context from semantic memory store 218, and/or a prompt that was generated based on a prompt template of a skill from skill library 112, 120, and/or 212 according to aspects described herein.

Further, positional encoding 560 may introduce information about the relative and/or absolute position for tokens of input embedding 558. Similarly, output embedding 574 includes a sequence of symbol representations that correspond to output 572, while positional encoding 576 may similarly introduce information about the relative and/or absolute position for tokens of output embedding 574.

As illustrated, encoder 552 includes example layer 570. It will be appreciated that any number of such layers may be used, and that the depicted architecture is simplified for illustrative purposes. Example layer 570 includes two sub-layers: multi-head attention layer 562 and feed forward layer 566. In examples, a residual connection is included around each layer 562, 566, after which normalization layers 564 and 568, respectively, are included.

Decoder 554 includes example layer 590. Similar to encoder 552, any number of such layers may be used in other examples, and the depicted architecture of decoder 554 is simplified for illustrative purposes. As illustrated, example layer 590 includes three sub-layers: masked multi-head attention layer 578, multi-head attention layer 582, and feed forward layer 586. Aspects of multi-head attention layer 582 and feed forward layer 586 may be similar to those discussed above with respect to multi-head attention layer 562 and feed forward layer 566, respectively. Additionally, masked multi-head attention layer 578 performs multi-head attention over the output of encoder 552 (e.g., output 572). In examples, masked multi-head attention layer 578 prevents positions from attending to subsequent positions. Such masking, combined with offsetting the embeddings (e.g., by one position, as illustrated by multi-head attention layer 582), may ensure that a prediction for a given position depends on known output for one or more positions that are less than the given position. As illustrated, residual connections are also included around layers 578, 582, and 586, after which normalization layers 580, 584, and 588, respectively, are included.

Multi-head attention layers 562, 578, and 582 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 5B (e.g., by a corresponding normalization layer 564, 580, or 584).

Feed forward layers 566 and 586 may each be a fully connected feed-forward network, which applies to each position. In examples, feed forward layers 566 and 586 each include a plurality of linear transformations with a rectified linear unit activation in between. In examples, each linear transformation is the same across different positions, while different parameters may be used as compared to other linear transformations of the feed-forward network.

Additionally, aspects of linear transformation 592 may be similar to the linear transformations discussed above with respect to multi-head attention layers 562, 578, and 582, as well as feed forward layers 566 and 586. Softmax 594 may further convert the output of linear transformation 592 to predicted next-token probabilities, as indicated by output probabilities 596. It will be appreciated that the illustrated architecture is provided in as an example and, in other examples, any of a variety of other model architectures may be used in accordance with the disclosed aspects. In some instances, multiple iterations of processing are performed according to the above-described aspects (e.g., using generative model package 504 in FIG. 5A or encoder 552 and decoder 554 in FIG. 5B) to generate a series of output tokens (e.g., words), for example which are then combined to yield a complete sentence (and/or any of a variety of other content). It will be appreciated that other generative models may generate multiple output tokens in a single iteration and may thus used a reduced number of iterations or a single iteration.

Accordingly, output probabilities 596 may thus form chained ML evaluation output 506 according to aspects described herein, such that the output of the generative ML model (e.g., which may include structured output) is used as input for a subsequent skill of a skill chain according to aspects described herein (e.g., similar to a “YES” determination at determination 314 of method 300 in FIG. 3). In other examples, chained ML evaluation output 506 is provided as generated output after processing a skill chain (e.g., similar to aspects of operation 316 of method 300), which may further be processed according to the disclosed aspects.

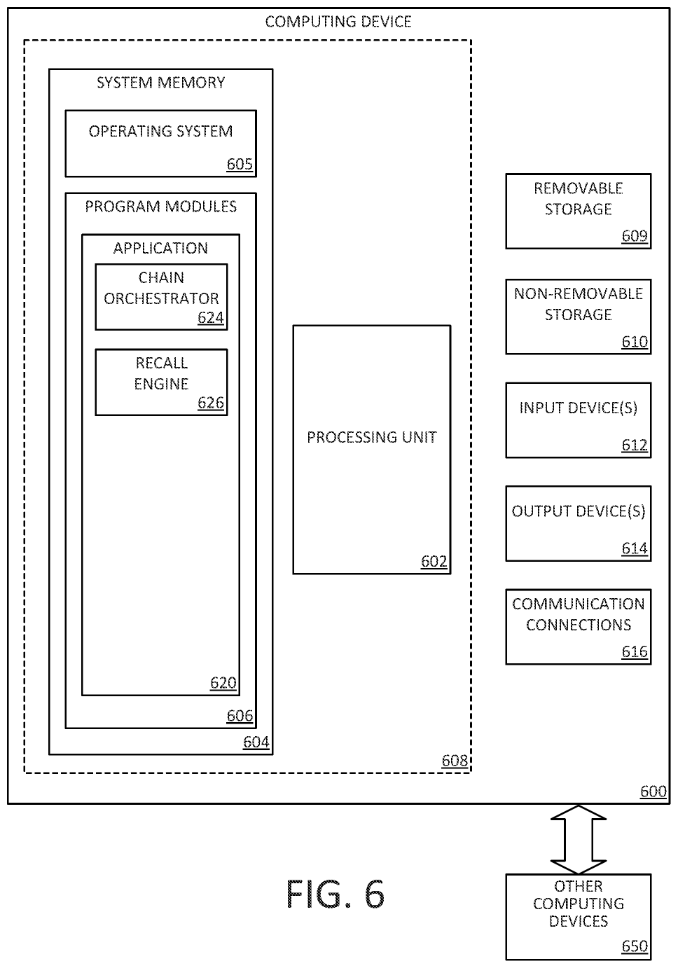

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including one or more devices associated with machine learning service 102, as well as computing device 104 discussed above with respect to FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may store chain orchestrator 624 and recall engine 626. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

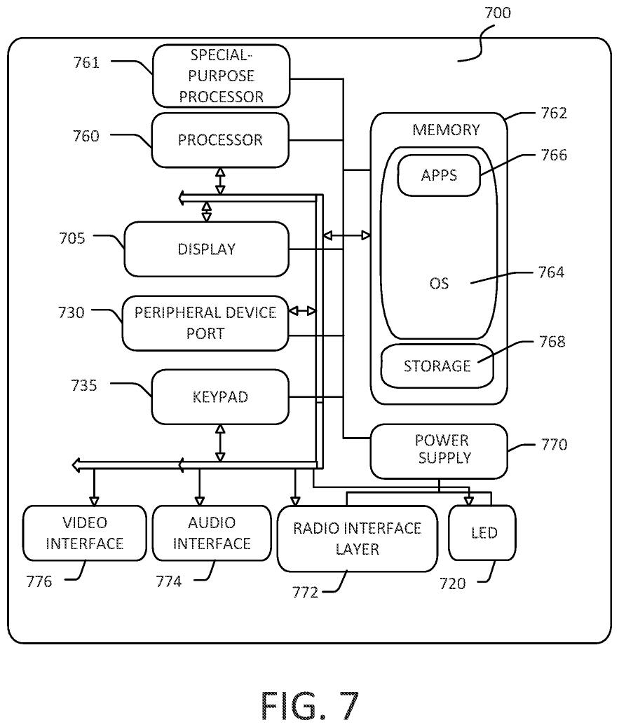

FIG. 7 illustrates a system 700 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 700 is implemented as a “smart phone” capable of running one or more applications (e.g., browser, e-mail, calendaring, contact managers, messaging clients, games, and media clients/players). In some aspects, the system 700 is integrated as a computing device, such as an integrated personal digital assistant (PDA) and wireless phone.

In a basic configuration, such a mobile computing device is a handheld computer having both input elements and output elements. The system 700 typically includes a display 705 and one or more input buttons that allow the user to enter information into the system 700. The display 705 may also function as an input device (e.g., a touch screen display).

If included, an optional side input element allows further user input. For example, the side input element may be a rotary switch, a button, or any other type of manual input element. In alternative aspects, system 700 may incorporate more or less input elements. For example, the display 705 may not be a touch screen in some embodiments. In another example, an optional keypad 735 may also be included, which may be a physical keypad or a “soft” keypad generated on the touch screen display.

In various embodiments, the output elements include the display 705 for showing a graphical user interface (GUI), a visual indicator (e.g., a light emitting diode 720), and/or an audio transducer 725 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 700 also includes a non-volatile storage area 768 within the memory 762. The non-volatile storage area 768 may be used to store persistent information that should not be lost if the system 700 is powered down. The application programs 766 may use and store information in the non-volatile storage area 768, such as e-mail or other messages used by an e-mail application, and the like. A synchronization application (not shown) also resides on the system 700 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the system 700 described herein.

The system 700 has a power supply 770, which may be implemented as one or more batteries. The power supply 770 might further include an external power source, such as an AC adapter or a powered docking cradle that supplements or recharges the batteries.

The system 700 may also include a radio interface layer 772 that performs the function of transmitting and receiving radio frequency communications. The radio interface layer 772 facilitates wireless connectivity between the system 700 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 700 may further include a video interface 776 that enables an operation of an on-board camera 730 to record still images, video stream, and the like.

It will be appreciated that system 700 may have additional features or functionality. For example, system 700 may also include additional data storage devices (removable and/or non-removable) such as, magnetic disks, optical disks, or tape. Such additional storage is illustrated in FIG. 7 by the non-volatile storage area 768.

Data/information generated or captured and stored via the system 700 may be stored locally, as described above, or the data may be stored on any number of storage media that may be accessed by the device via the radio interface layer 772 or via a wired connection between the system 700 and a separate computing device associated with the system 700, for example, a server computer in a distributed computing network, such as the Internet. As should be appreciated, such data/information may be accessed via the radio interface layer 772 or via a distributed computing network. Similarly, such data/information may be readily transferred between computing devices for storage and use according to any of a variety of data/information transfer and storage means, including electronic mail and collaborative data/information sharing systems.

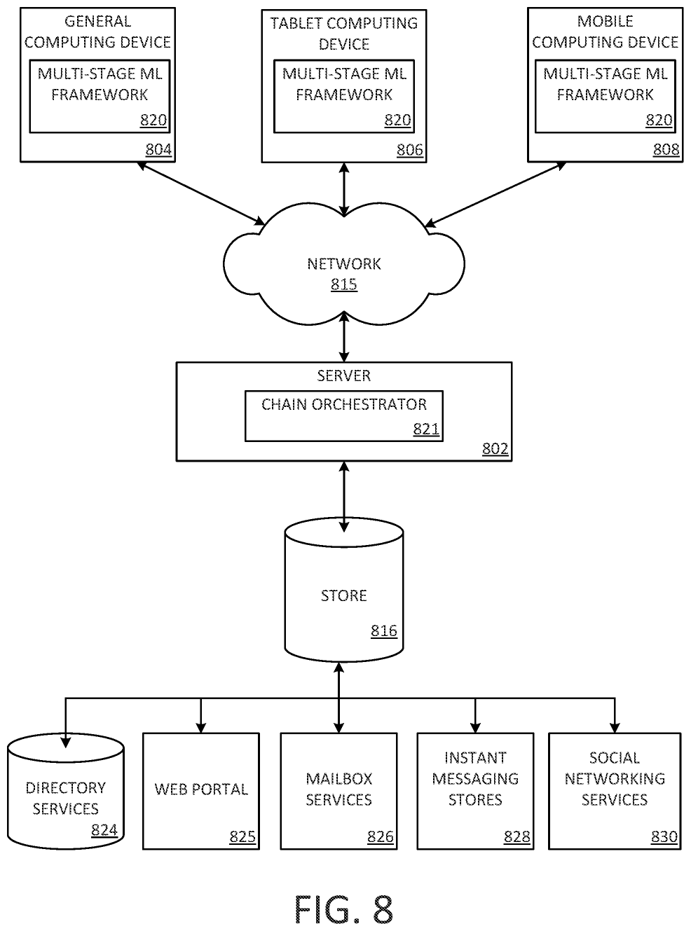

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 824, a web portal 825, a mailbox service 826, an instant messaging store 828, or a social networking site 830.

A multi-stage machine learning framework 820 (e.g., similar to the application 620) may be employed by a client that communicates with server device 802. Additionally, or alternatively, chain orchestrator 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these examples of the computing devices may obtain content from the store 816, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, cause the system to perform a set of operations. The set of operations comprises: obtaining user input from a user; generating, based on the user input, a skill chain that includes a set of skills with which to process the user input; for a first model skill of the skill chain: generating, based on a first prompt template associated with the first model skill, a first prompt that includes at least a part of the obtained user input; and processing, using a first machine learning model associated with the first model skill, the first prompt to obtain intermediate output; for a second model skill of the skill chain: generating, based on a second prompt template associated with the second model skill, a second prompt that includes at least a part of the intermediate output as input for the second model skill; and processing, using a second machine learning model associated with the second model skill, the second prompt to obtain model output; and providing an indication of the model output for display to the user. In an example, generating the skill chain comprises: generating a skill listing corresponding to a set of skills of a skill library, wherein the skill listing includes a description for each skill of the set of skills; providing, to a machine learning service, an indication of the user input and the skill listing; and receiving, from the machine learning service, the skill chain corresponding to the user input. In another example, generating the skill chain comprises: generating, for the user input, an input embedding that encodes an intent of the user input; determining, from a skill library, a set of skills that each have an associated semantic embedding that matches the generated input embedding; and generating the skill chain based on the determined set of skills. In a further example, it is determined that a semantic embedding matches the input embedding based on an algorithmic similarity metric between the semantic embedding and the input embedding. In yet another example, processing the first prompt to obtain the intermediate output comprises: providing, to a machine learning service, a request to process the first prompt using the first machine learning model; and receiving, from the machine learning service, a response that includes the intermediate output. In a further still example, the intermediate output of the first model skill includes structured output. In another example, at least a part the first prompt corresponds to the structured output.

In another aspect, the technology relates to a method. The method comprises: obtaining, at a computing device, a skill chain corresponding to an input; for a first model skill of the skill chain: generating, based on a first prompt template associated with the first model skill, a first prompt that includes at least a part of the user input; and processing, using a first machine learning model associated with the first model skill, the first prompt to obtain intermediate output; for a second model skill of the skill chain: generating, based on a second prompt template associated with the second model skill, a second prompt that includes at least a part of the intermediate output as input for the second model skill; and processing, using a second machine learning model associated with the second model skill, the second prompt to obtain model output; and processing, by the computing device, at least a part of the model output to affect operation of the computing device. In an example, the first machine learning model is the second machine learning model. In another example, the skill chain further comprises a programmatic skill that is performed by the computing device; and output of the programmatic skill is processed as input for the second model skill. In a further example, the intermediate output of the first model skill includes structured output that is processed by the programmatic skill. In yet another example, processing the part of the model output comprises displaying the part of the model output to a user of the computing device. In a further still example, processing the part of the model output comprises parsing, by an application of the computing device, the part of the model output to affect operation of the application.

In a further aspect, the technology relates to another method. The method comprises: obtaining user input from a user; generating, based on the user input, a skill chain that includes a set of skills with which to process the user input; for a first model skill of the skill chain: generating, based on a first prompt template associated with the first model skill, a first prompt that includes at least a part of the obtained user input; and processing, using a first machine learning model associated with the first model skill, the first prompt to obtain intermediate output; for a second model skill of the skill chain: generating, based on a second prompt template associated with the second model skill, a second prompt that includes at least a part of the intermediate output as input for the second model skill; and processing, using a second machine learning model associated with the second model skill, the second prompt to obtain model output; and providing an indication of the model output for display to the user. In an example, generating the skill chain comprises: generating a skill listing corresponding to a set of skills of a skill library, wherein the skill listing includes a description for each skill of the set of skills; providing, to a machine learning service, an indication of the user input and the skill listing; and receiving, from the machine learning service, the skill chain corresponding to the user input. In another example, generating the skill chain comprises: generating, for the user input, an input embedding that encodes an intent of the user input; determining, from a skill library, a set of skills that each have an associated semantic embedding that matches the generated input embedding; and generating the skill chain based on the determined set of skills. In a further example, it is determined that a semantic embedding matches the input embedding based on an algorithmic similarity metric between the semantic embedding and the input embedding. In yet another example, processing the first prompt to obtain the intermediate output comprises: providing, to a machine learning service, a request to process the first prompt using the first machine learning model; and receiving, from the machine learning service, a response that includes the intermediate output. In a further still example, the intermediate output of the first model skill includes structured output. In another example, at least a part the first prompt corresponds to the structured output.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
obtaining user input from a user;
generating, based on the user input, a skill chain that includes a set of skills with which to process the user input;
for a first model skill of the skill chain:
generating, based on a first prompt template associated with the first model skill, a first prompt that includes at least a part of the obtained user input; and
processing, using a first machine learning model associated with the first model skill, the first prompt to obtain intermediate output;
for a second model skill of the skill chain:
generating, based on a second prompt template associated with the second model skill, a second prompt that includes at least a part of the intermediate output as input for the second model skill; and
processing, using a second machine learning model associated with the second model skill, the second prompt to obtain model output; and
providing an indication of the model output for display to the user.

2. The system of claim 1, wherein generating the skill chain comprises:
generating a skill listing corresponding to a set of skills of a skill library, wherein the skill listing includes a description for each skill of the set of skills;
providing, to a machine learning service, an indication of the user input and the skill listing; and
receiving, from the machine learning service, the skill chain corresponding to the user input.

3. The system of claim 1, wherein generating the skill chain comprises:
generating, for the user input, an input embedding that encodes an intent of the user input;
determining, from a skill library, a set of skills that each have an associated semantic embedding that matches the generated input embedding; and
generating the skill chain based on the determined set of skills.

4. The system of claim 3, wherein it is determined that a semantic embedding matches the input embedding based on an algorithmic similarity metric between the semantic embedding and the input embedding.

5. The system of claim 1, wherein processing the first prompt to obtain the intermediate output comprises:
providing, to a machine learning service, a request to process the first prompt using the first machine learning model; and
receiving, from the machine learning service, a response that includes the intermediate output.

6. The system of claim 1, wherein the intermediate output of the first model skill includes structured output.

7. The system of claim 6, wherein at least a part the first prompt corresponds to the structured output.

8. A method, comprising:
obtaining, at a computing device, a skill chain corresponding to an input;
for a first model skill of the skill chain:
generating, based on a first prompt template associated with the first model skill, a first prompt that includes at least a part of the user input; and
processing, using a first machine learning model associated with the first model skill, the first prompt to obtain intermediate output;
for a second model skill of the skill chain:
generating, based on a second prompt template associated with the second model skill, a second prompt that includes at least a part of the intermediate output as input for the second model skill; and
processing, using a second machine learning model associated with the second model skill, the second prompt to obtain model output; and
processing, by the computing device, at least a part of the model output to affect operation of the computing device.

9. The method of claim 8, wherein the first machine learning model is the second machine learning model.

10. The method of claim 8, wherein:
the skill chain further comprises a programmatic skill that is performed by the computing device; and
output of the programmatic skill is processed as input for the second model skill.

11. The method of claim 10, wherein the intermediate output of the first model skill includes structured output that is processed by the programmatic skill.

12. The method of claim 8, wherein processing the part of the model output comprises displaying the part of the model output to a user of the computing device.

13. The method of claim 8, wherein processing the part of the model output comprises parsing, by an application of the computing device, the part of the model output to affect operation of the application.

14. A method, comprising:
obtaining user input from a user;
generating, based on the user input, a skill chain that includes a set of skills with which to process the user input;
for a first model skill of the skill chain:
generating, based on a first prompt template associated with the first model skill, a first prompt that includes at least a part of the obtained user input; and
processing, using a first machine learning model associated with the first model skill, the first prompt to obtain intermediate output;
for a second model skill of the skill chain:
generating, based on a second prompt template associated with the second model skill, a second prompt that includes at least a part of the intermediate output as input for the second model skill; and
processing, using a second machine learning model associated with the second model skill, the second prompt to obtain model output; and
providing an indication of the model output for display to the user.

15. The method of claim 14, wherein generating the skill chain comprises:
generating a skill listing corresponding to a set of skills of a skill library, wherein the skill listing includes a description for each skill of the set of skills;
providing, to a machine learning service, an indication of the user input and the skill listing; and
receiving, from the machine learning service, the skill chain corresponding to the user input.

16. The method of claim 14, wherein generating the skill chain comprises:
generating, for the user input, an input embedding that encodes an intent of the user input;
determining, from a skill library, a set of skills that each have an associated semantic embedding that matches the generated input embedding; and
generating the skill chain based on the determined set of skills.

17. The method of claim 16, wherein it is determined that a semantic embedding matches the input embedding based on an algorithmic similarity metric between the semantic embedding and the input embedding.

18. The method of claim 14, wherein processing the first prompt to obtain the intermediate output comprises:
providing, to a machine learning service, a request to process the first prompt using the first machine learning model; and
receiving, from the machine learning service, a response that includes the intermediate output.

19. The method of claim 14, wherein the intermediate output of the first model skill includes structured output.

20. The method of claim 19, wherein at least a part the first prompt corresponds to the structured output.
